(19) United States
(12) Patent Application Publication
(10) Pub. No.: US 2018/0011898 A1
(43) Pub. Date: Jan. 11, 2018

(54) DATA COLLECTION METHOD AND SYSTEM

(71) Applicant: AVOKA TECHNOLOGIES PTY LTD, Manly (AU)

(72) Inventors: Derek John CORCORAN, Newtown (AU); Willem Jeroen SWIEBEL, Mount Waverley (AU); Parth PANDYA, Mount Waverley (AU)

(73) Assignee: AVOKA TECHNOLOGIES PTY LTD, Manly (AU)

(21) Appl. No.: 15/203,584

(22) Filed: Jul. 6, 2016

(51) Int. Cl. G06F 17/30

(52) U.S. Cl. CPC G06F 17/30389; G06F 17/30477

(57) ABSTRACT

Disclosed is a computer implemented data collection method and system. In one aspect the method includes: transferring a message indicative of a form question of a form via a communication service for presentation in a conversational format upon a data entry processing system; receiving, via the communication service, a response in a conversational format from the user operating the data entry processing system; attempting to interpret the response using an expert system; in the event that the response data is interpreted as an answer, recording the answer as part of form instance data; and in the event that the response cannot be interpreted by the expert system, facilitating a data collection user to conduct a portion of the data collection session via the data collection processing system, wherein input is subsequently received from the data collection user to continue interpreting further responses during the form collection session.

### TECHNICAL FIELD

The present invention relates to a computer implemented data collection method and system.

### BACKGROUND OF THE INVENTION

In the field of data entry (also described here as forms-based transactions or form-filling), users normally are provided with a series of fields on the screen generally via a website. The form generally includes a plurality of question (also known as a caption) and a respective plurality of data entry areas. The user is expected to use an input device, such as a keyboard and/or mouse to enter information into the data entry area. More sophisticated forms also implement rules that govern the information entered. For example, one field may be mandatory. In another example, a form may only accept numbers between a defined range for a particular field.

Many users find the process of filling out a form in the above manner tedious and/or difficult. This can lead to users failing to complete the form. Additionally or alternatively, due to the tedium of this task, users may provide inaccurate information.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

### SUMMARY OF THE INVENTION

In a first aspect there is provided a method performed by a data collection processing system for conducting a data collection session to complete a form for a user, wherein the method includes:

transferring a message indicative of a form question of a form via a communication service for presentation in a conversational format upon a data entry processing system;

receiving, via the communication service, a response in a conversational format from the user operating the data entry processing system;

attempting to interpret the response using an expert system;

in the event that the response data is interpreted as an answer to the form question, recording the answer in a data store as part of form instance data; and

in the event that the response cannot be interpreted by the expert system, facilitating a data collection user to conduct a portion of the data collection session via the data collection processing system, wherein the method subsequently includes receiving input from the data collection user that the expert system is to continue interpreting further responses received from the data entry processing system during the form collection session.

In certain embodiments, in the event that the response data is interpreted as the answer to the form question, the method includes determining, using a form interpreter and form definition data, if the answer is valid, wherein in response to the answer being invalid, the method further includes the expert system generating and transferring a further message to the data entry processing system indicative of the answer being invalid and re-presenting the form question.

In certain embodiments, the method further includes the expert system interpreting the response data as being indicative of a query, wherein the expert system is configured to generate a query response based on knowledge base data and transfer the query response to the data entry processing system via the communication service.

In certain embodiments, the method further includes:

accessing form data stored in a data store including a form definition file defining a plurality of form fields of the form;

obtaining a caption associated with one of the form fields defined by the form definition file to generate the message indicative of the form question.

In certain embodiments, the method further includes the data collection processing system:

receiving interpretation data indicative of an interpretation of the response by the data collection user is used by the data collection processing system; and

updating knowledge base data for the expert system based on the interpretation data.

In certain embodiments, the data collection processing system is a distributed processing system including a server processing system in data communication with a data collection client processing system operated by the data collection user, wherein in the event that the response cannot be interpreted by the expert system the method further includes the server processing system transferring a data collection interface to the data collection client processing system for enabling the data collection user to conduct a portion of the data collection session.

In certain embodiments, the method includes the server processing system generating the data collection interface to include a conversational portion indicative of the message and the response, and a form instance portion indicative of the form instance data.

In a second aspect there is provided a data collection processing system for conducting a data collection session to complete a form for a user, wherein the data collection processing system includes a memory coupled to a processor configured to:

transfer a message indicative of a form question of a form via a communication service for presentation in a conversational format upon a data entry processing system;

receive, via the communication service, a response in a conversational format from the user operating the data entry processing system;

attempt to interpret the response using an expert system;

in the event that the response data is interpreted as an answer to the form question, record the answer in the memory as part of form instance data; and

in the event that the response cannot be interpreted by the expert system, facilitate a data collection user to conduct a portion of the data collection session via the data collection processing system, wherein the method subsequently includes receiving input from the data collection user that the expert system is to continue interpreting further responses received from the data entry processing system during the form collection session.

In certain embodiments, the data collection processing system includes a form interpreter, wherein in the event that the response data is interpreted as the answer to the form question, the form interpreter is configured to determine, using form definition data of the form, if the answer is valid, wherein in response to the answer being invalid, the expert system is configured to generate and transfer a further message to the data entry processing system indicative of the answer being invalid and re-presenting the form question.

In certain embodiments, the expert system interprets the response data as being indicative of a query, wherein the expert system is configured to generate a query response based on knowledge base data and transfer the query response to the data entry processing system via the communication service.

In certain embodiments, expert system is configured to:

access form data stored in a data store including a form definition file defining a plurality of form fields of the form; and

obtain a caption associated with one of the form fields to generate the message indicative of the form question.

In certain embodiments, the data collection processing system is further configured to:

receive interpretation data indicative of an interpretation of the response by the data collection user is used by the data collection processing system; and

update knowledge base data for the expert system based on the interpretation data.

In certain embodiments, the data collection processing system is a distributed processing system including a server processing system in data communication with a data collection client processing system operated by the data collection user, wherein in the event that the response cannot be interpreted by the expert system, the server processing system is configured to transfer a data collection interface to the data collection client processing system for enabling the data collection user to conduct a portion of the data collection session.

In certain embodiments, the server processing system is configured to generate the data collection interface to include a conversational portion indicative of the message and the response, and a form instance portion indicative of the form instance data.

In a third aspect there is provided a non-transient computer readable medium for configured a data collection processing system for conducting a data collection session to complete a form for a user, wherein the non-transient computer readable medium includes executable instructions for configured the data collection processing system to:

transfer a message indicative of a form question of a form via a communication service for presentation in a conversational format upon a data entry processing system;

receive, via the communication service, a response in a conversational format from the user operating the data entry processing system;

attempt to interpret the response using an expert system;

in the event that the response data is interpreted as an answer to the form question, record the answer in the memory as part of form instance data; and

in the event that the response cannot be interpreted by the expert system, facilitate a data collection user to conduct a portion of the data collection session via the data collection processing system, wherein the method subsequently includes receiving input from the data collection user that the expert system is to continue interpreting further responses received from the data entry processing system during the form collection session.

In certain embodiments, the data collection processing system includes a form interpreter, wherein in the event that the response data is interpreted as the answer to the form question, the form interpreter is configured to determine, using form definition data of the form, if the answer is valid, wherein in response to the answer being invalid, the expert system is configured to generate and transfer a further message to the data entry processing system indicative of the answer being invalid and re-presenting the form question.

In certain embodiments, in the expert system interprets the response data as being indicative of a query, wherein the expert system is configured to generate a query response based on knowledge base data and transfer the query response to the data entry processing system via the communication service.

In certain embodiments, the expert system is configured to:

access form data stored in a data store including a form definition file defining a plurality of form fields of the form; and

obtain a caption associated with one of the form fields to generate the message indicative of the form question.

In certain embodiments, the data collection processing system is further configured to:

receive interpretation data indicative of an interpretation of the response by the data collection user is used by the data collection processing system; and

update knowledge base data for the expert system based on the interpretation data.

In certain embodiments, the data collection processing system is a distributed processing system including a server processing system in data communication with a data collection client processing system operated by the data collection user, wherein in the event that the response cannot be interpreted by the expert system, the server processing system is configured to transfer a data collection interface to the data collection client processing system for enabling the data collection user to conduct a portion of the data collection session.

In certain embodiments, the server processing system is configured to generate the data collection interface to include a conversational portion indicative of the message and the response, and a form instance portion indicative of the form instance data.

Other aspects and embodiments will be appreciated throughout the detailed description.

### BRIEF DESCRIPTION OF THE DRAWINGS

Example embodiments should become apparent from the following description, which is given by way of example only, of at least one preferred but non-limiting embodiment, described in connection with the accompanying figures.

FIG. 1 illustrates a functional block diagram of an example processing device that can be utilized to embody or give effect to a particular embodiment;

FIG. 2 illustrates an example network infrastructure that can be utilized to embody or give effect to a particular embodiment;

FIG. 3 illustrates an example data collection system;

FIG. 4 illustrates an example method for performed by the data collection system;

FIG. 5 illustrates a more detailed system diagram of a data collection system based on FIG. 3;

FIG. 6 illustrates an example conversational interface presented by a data entry processing system.

### DESCRIPTION OF THE PREFERRED EMBODIMENTS

The following modes, given by way of example only, are described in order to provide a more precise understanding of the subject matter of a preferred embodiment or embodiments.

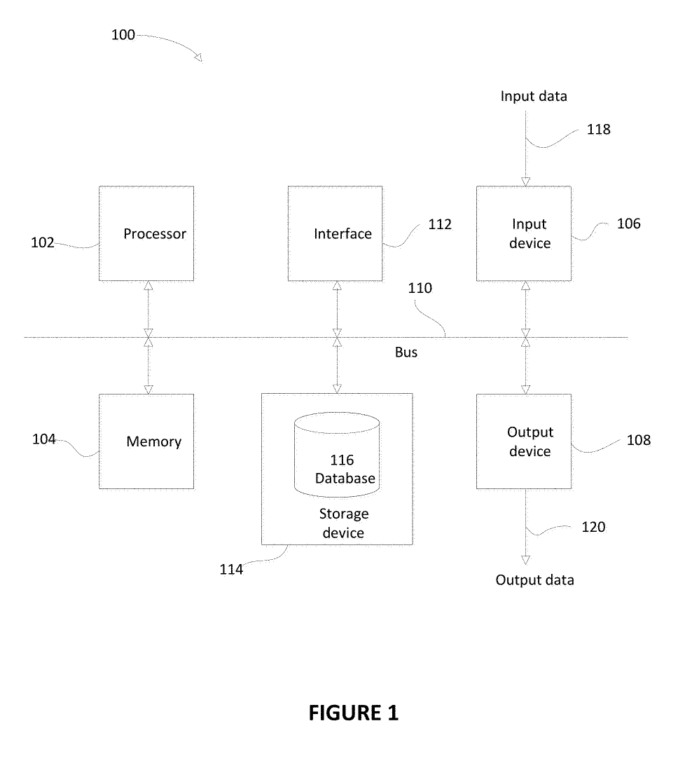

A particular embodiment of the present invention can be realised using a processing device, an example of which is shown in FIG. 1. In particular, the processing device 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing device 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing device 100.

Input device 106 receives input data 118 (such as electronic content data), for example via a network or from a local storage device. Output device 108 produces or generates output data 120 (such as viewable content) and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

Examples of electronic data storage devices 114 can include disk storage, optical discs, such as CD, DVD, Blu-ray Disc, flash memory/memory card (e.g., solid state semiconductor memory), MultiMedia Card, USB sticks or keys, flash drives, Secure Digital (SD) cards, microSD cards, miniSD cards, SDHC cards, miniSDSC cards, solid-state drives, and the like.

In use, the processing device 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing device 100 may be any form of terminal, PC, laptop, notebook, tablet, smart phone, specialised hardware, or the like.

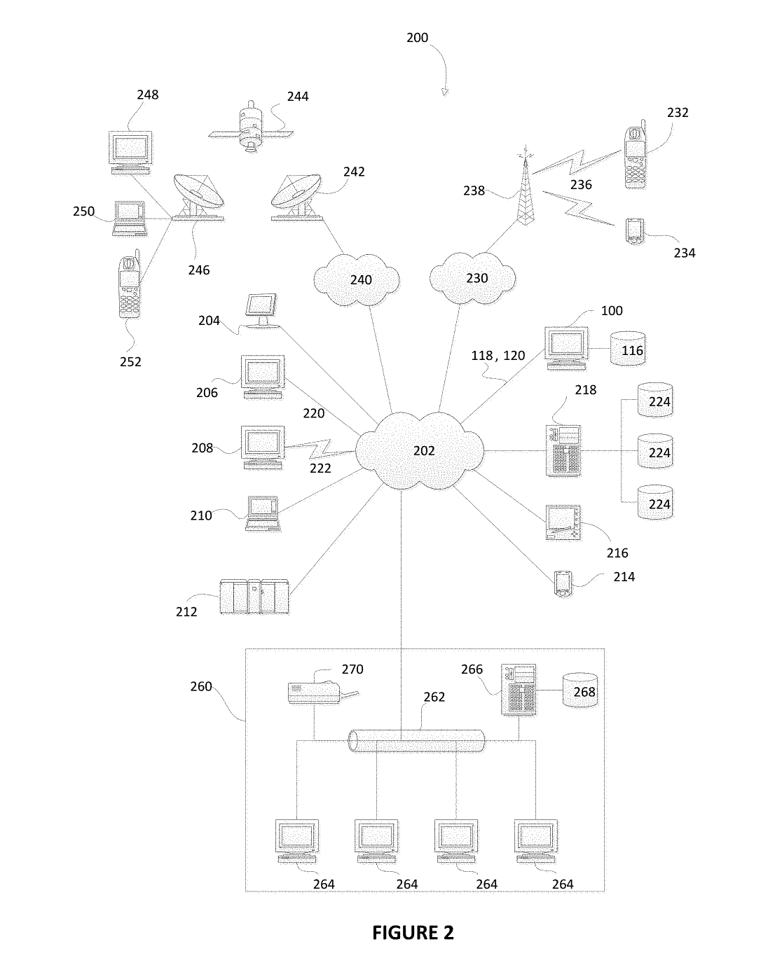

The processing device 100 may be a part of a networked communications system 200, as shown in FIG. 2. Processing device 100 could connect to network 202, for example the Internet or a WAN. Input data 118 and output data 120 could be communicated to other devices via network 202. Other terminals, for example, thin client 204, further processing systems 206 and 208, notebook computer 210, mainframe computer 212, PDA 214, pen-based computer 216, server 218, etc., can be connected to network 202. A large variety of other types of terminals or configurations could be utilized. The transfer of information and/or data over network 202 can be achieved using wired communications means 220 or wireless communications means 222. Server 218 can facilitate the transfer of data between network 202 and one or more databases 224. Server 218 and one or more databases 224 provide an example of an information source.

Other networks may communicate with network 202. For example, telecommunications network 230 could facilitate the transfer of data between network 202 and mobile or cellular telephone 232 or a PDA-type device 234, by utilising wireless communication means 236 and receiving/transmitting station 238. Satellite communications network 240 could communicate with satellite signal receiver 242 which receives data signals from satellite 244 which in turn is in remote communication with satellite signal transmitter 246. Terminals, for example further processing system 248, notebook computer 250 or satellite telephone 252, can thereby communicate with network 202. A local network 260, which for example may be a private network, LAN, etc., may also be connected to network 202. For example, network 202 could be connected with ethernet 262 which connects terminals 264, server 266 which controls the transfer of data to and/or from database 268, and printer 270. Various other types of networks could be utilised.

The processing device 100 is adapted to communicate with other terminals, for example further processing systems 206, 208, by sending and receiving data, 118, 120, to and from the network 202, thereby facilitating possible communication with other components of the networked communications system 200.

Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, ethernet, token ring, FDDI ring, star, etc., networks, or mobile telephone networks, such as GSM, CDMA or 3G, 4G, etc., networks, and may be wholly or partially wired, including for example optical fibre, or wireless networks, depending on a particular implementation.

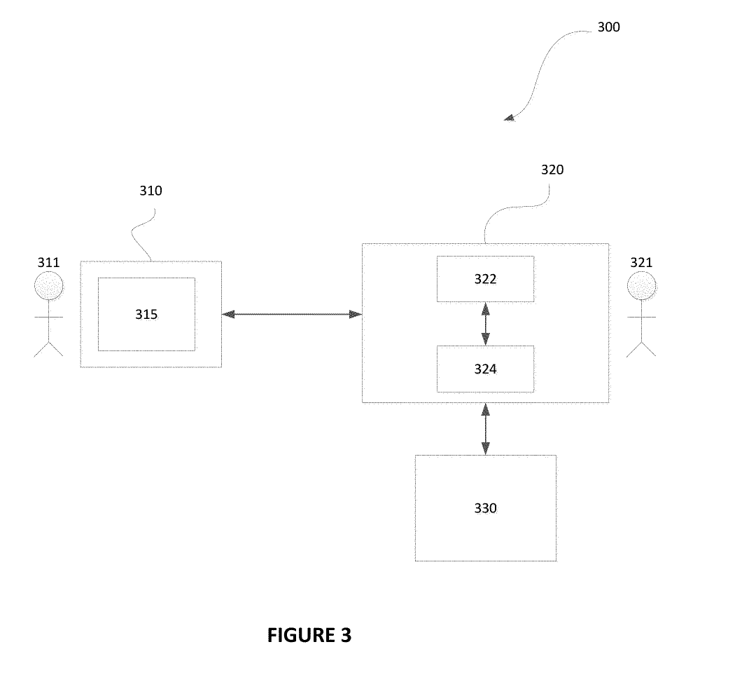

Referring to FIG. 3 there is shown an example of a data collection system 300. The system includes a data collection processing system 310 in data communication with a data entry processing system 320 via one or more networks. Data communication between the data collection processing system 320 and the data entry processing system 310 can occur via one or more computer networks, such as the Internet, and/or one or more telecommunication networks.

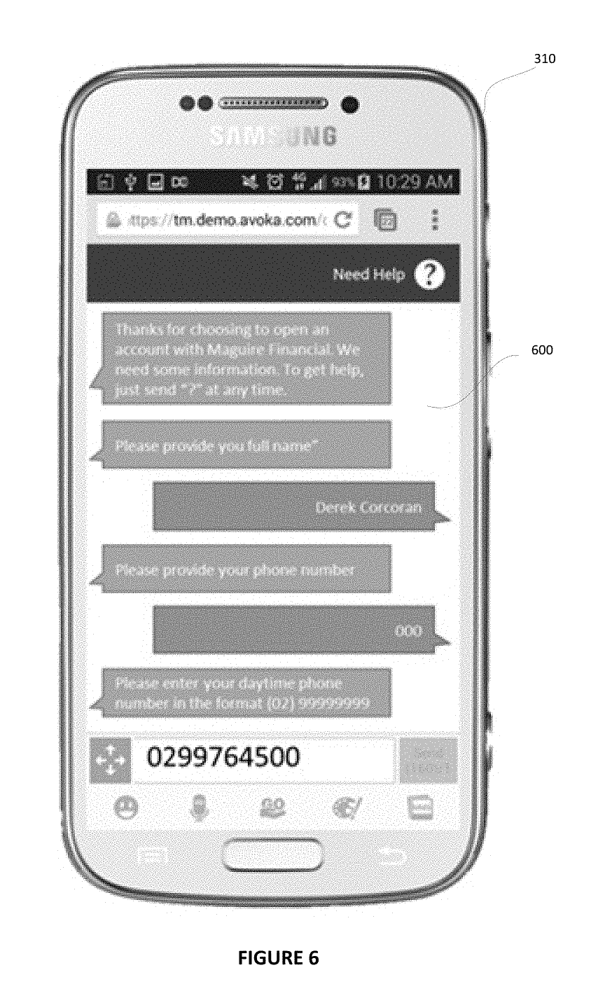

The data entry processing system 310 can include a general processing system, a mobile communication device such as a smart phone, or the like which is operated by a user 311. The data entry processing system 310 includes a first computer program 315 providing a conversational interface for allowing the user 311 to receive and display a series of unstructured text-based messages for completing a form. An example of a conversational interface 600 is shown in FIG. 6. The responding messages presented within the conversational interface 600 are the user's responses to the form questions which are transferred to the data collection processing system 320 in a conversational format.

This conversational style of obtaining from data from a user 311 is advantageous as it is more appealing to many modern users using technologies that they are already familiar with such as messaging applications and the like. Therefore, this data collection system and method seeks to reduce the number of abandonments of completing the form.

The first computer program 315 can take the form of a communication program or messaging program used for enabling communication or messaging between two or more human users. For example, the first computer program 315 may be provided in the form of a client computer program such as Twitter, Skype, or Whatsapp. The first computer program 315 could alternatively be an interface to enable communication via a series of messages using short message service (SMS).

The data collection processing system 320 is configured by one or more computer programs. In one form, the one or more computer programs includes an expert system 322 and a form interpreter 324. The data collection processing system 320 can be a single processing system or a distributed processing system. In some instances, different processing systems execute the expert system 322 and the form interpreter 324 wherein data is transferred between separate processing systems using one or more networks.

The expert system 322 of the data collection processing system 320 is configured to generate and transfer form questions in a conversational format to the data entry processing system 310 via the communication/messaging service. The expert system 322 is also used to attempt to interpret responses received from the data entry processing system 310 and take appropriate action to continue the data collection process.

The form interpreter 324 of the data collection processing system 320 is configured to determine whether particular response data, which is interpreted as an answer to a form field of the form by the expert system 322, is valid according to one or more form rules.

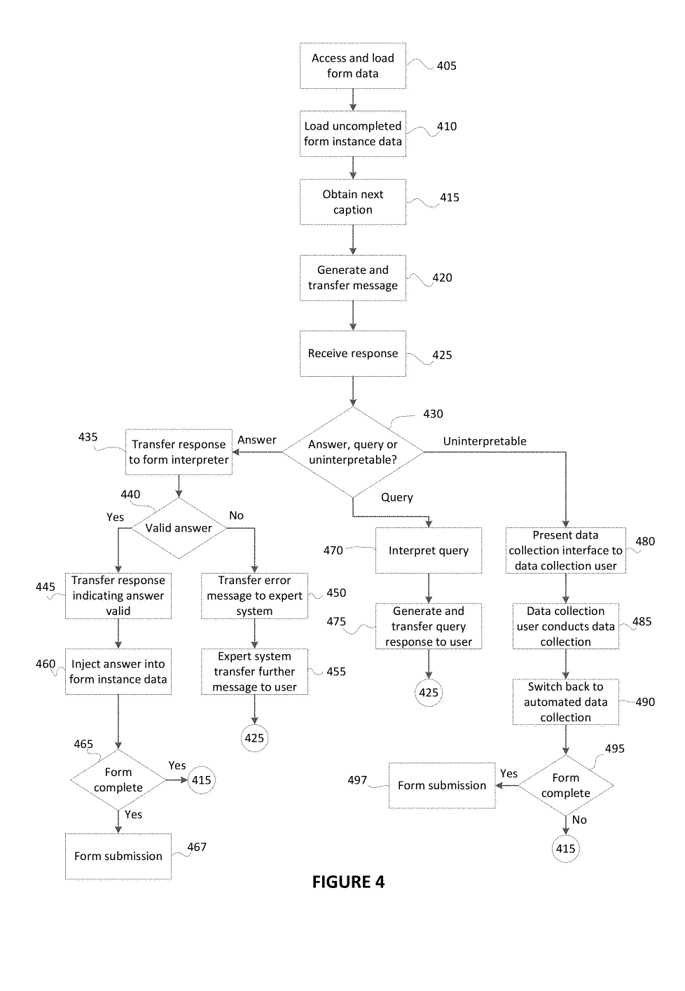

Referring to FIG. 4 there is shown a flowchart 400 representing a method performed by the expert system and the form interpreter.

At step 405, the method includes the expert system 322 is configured to access and load form data stored in a data store 330 which represents an electronic form for completion by the user. The form data can include a form definition file which defines form fields and rules. The form data can also include form instance data indicative of an electronic form at least partially or completely filled with data based on interpreting user responses.

At step 410, the method includes the expert system 322 loading an uncompleted copy of the form instance data.

At step 415, the expert system 322 then obtains a caption associated with the next form field from the form data. In the event that the expert system 322 has only just loaded the form data, the next form field is in the first form field in the form.

At step 420, the expert system 322 facilitates generation and transfer of a message for transfer via the communication/messaging service to present the caption as a question to the user 311 at the data entry processing system 310.

At step 425, the expert system 322 receives a response from the user operating the data entry processing system 310 via the communication/messaging service.

At step 430, the expert system 322 attempts to interpret the response received from the user. The expert system 322 is configured to determine whether the response provided by the user was an answer, a query or cannot be interpreted.

In the event that the expert system 322 determines that the response was indicative of an answer, the method continues to step 435 where the expert system 322 transfers the response to the form interpreter 324. At step 440, the form interpreter 324 then determines, based on the form definition file, whether the response is valid for entry into the form. In the event that the form interpreter 324 determines that the response is suitable for entry into the form, the method proceeds to step 445 where the form interpreter 324 generates and transfers a response to the expert system 322 indicating that the response is valid and the method continues to step 465. Otherwise, at step 450, the method includes the form interpreter 324 transferring an error message to the expert system 322. At step 455 the expert system 322 generates a message indicative of the error message and the respective question again. At step 460, the method includes the expert system 322 transferring the generated message to the data entry processing system 310 for presentation via the communication/messaging interface 600. The method then proceeds back to step 425 waiting for a further response.

At step 460, in response to the expert system 322 receiving a response from the form interpreter 324 that the response is valid, the expert system 322 injects the answer into the form instance data. At step 465, the expert system 322 determines if the form is complete. If the form is not complete, the method proceeds back to step 415, otherwise the method submitting the form instance data for processing at step 467. The form instance data can be transferred via one or more networks to a further processing system 100 or stored in the data store 330 of the data collection processing system 320.

In the event that the expert system 322 determines that the response data is indicative of a query from the user, the method proceeds to step 470 where the expert system 322 attempts to interpret the query based on a knowledge base data and generate a response. At step 475, the method includes the expert system 322 transfers a query response to the user via the communication/messaging service. The method then proceeds back to 425 waiting for a further response from the user.

In the event that the response data cannot be interpreted by the expert system 322, step 480 is performed which includes the data collection processing system 320 presenting the response to a human operator 321 (herein a data collection user) for interpretation. At step 485, the human operator 321 conducts human data collection. At step 490, the method includes switching back to automated data collection. At step 495, the method includes determining if the form is complete. If the method is not complete, the method proceeds back to step 415, otherwise the method include step 497 which includes submitting the form for processing.

In a preferable form, the expert system 322 can be trained with previous responses from a plurality of users 311 completing the form or other forms in the past. Additionally, the expert system 322 can be trained in the area of form entry. The data collection processing system 320 can assign a unique data collection identifier for a data collection session with a user which is accessible by the expert system 320, wherein the interpretation of a particular user's conversational responses during a data collection session may be improved based on previous responses by the respective user during the data entry session.

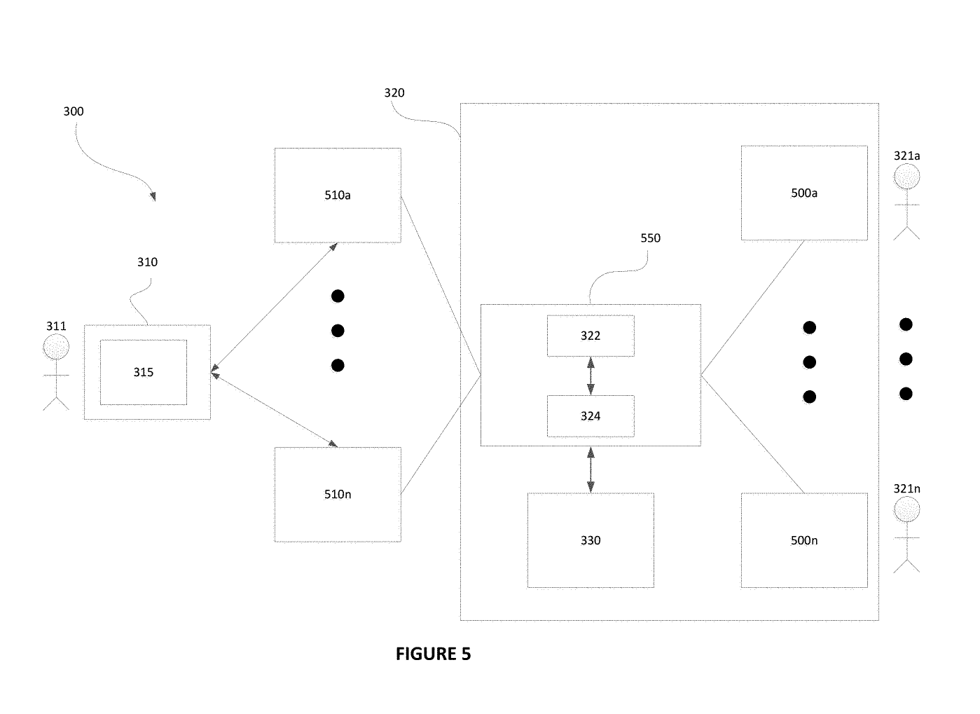

In one form as shown in FIG. 3, the data collection user 321 may be able to operate the data collection processing system 320 to interpret the user's conversational response and/or facilitate the data collection process. However, as shown in FIG. 5, the data collection processing system 320 may include a server processing system 550 in data communication with one or more data collection client processing systems 500a-500n operated by a respective one or more data collection users 321a-321n. When human input is required, data is transferred from the server processing system 550 to one of the one or more data collection client processing systems 500a-500n operated by the respective data collection user 321a-321n, wherein the respective data collection user 321 can assist with interpreting the user's conversational response and/or facilitate the data collection process with the user 311.

When human assistance is required from the data collection user 321, the data collection user 321 can be presented with a data collection interface. The data collection interface can include a conversation interface portion. The conversation interface portion of the data collection interface can present the conversational messages that have been transferred between the data processing system 320 and the data entry processing system 310 being operated by the data entry user 311. In one particular form, the conversational interface portion may be presented in the form of a threaded message interface showing the conversational styled messages that have been transferred by the data collection processing system 320 to the user 311 operating the data entry processing system 310, and the messages received by the data collection processing system 320 from the user operating the data entry processing system 320. The data collection interface can additionally include a form instance portion which presents data that has been injected into the form instance based on the data so far received from the user during the data collection session. The presentation of the data entry portion of the data collection interface can be useful to the data collection user 321 who may be able to interpret the user's conversational response based on previously recorded form instance data.

In some embodiments, the data collection user 321 may oversee and monitor the data collection process being conducted between the data collection processing system 320 and the user 311. Thus, when human assistance is required, little time is required for the user to interpret the user's response if possible. During periods where human assistance is not required, the data collection user 321 may not be able to participate in the data collection conversation. Buttons of the data collection interface may be disabled to prevent the data collection user participating in the data collection process. However, once the expert system 322 determines that human input is required, the data collection interface is enabled such that the data collection user is able to facilitate interpreting the user's response, record form instance data based on the human interpretation provided by the data collection user, or allow input and transfer of one or more further conversational messages to the user 311 at the data entry processing system 310.

In order to highlight to the data collection user 321 that human assistance is required during the data collection session, an audible sound may be emitted by a speaker or the like of one of the processing system 500a-500n being operated by the data collection user 321. Additionally or alternatively, a visual cue, such a flashing occurring on the display or a change in the color of the visual interface, may be presented to the data collection user 321 to draw their attention that human assistance is required. In some instances, the data collection user 321 may monitor multiple data collection sessions simultaneously.

In some instances, the data collection user 321 may not be needed to monitor the data collection session. When human input is required, the data collection interface is presented to the data collection user by the data collection processing system 320. The data collection user can then review the portions of the interface and interpret the response by the user.

In some situations, the server processing system 550 maintains in memory a queue of a plurality of data collection users. When human assistance is required, the server processing system determines the next data collection user in the queue and then transfers data indicative of the data collection interface to the data collection client processing system 550a-550n being operated by the data collection user 321. The respective data collection user 321 is then removed from the queue whilst human assistance is being provided. Once human assistance is no longer required, the data collection user 321 is then reintroduced at the tail of the queue ready to provide assistance for the same or a different data collection session.

In one form, the data collection interface can include an interactable interface element, such as a selectable button, to allow the data collection user to switch control of the data collection process back to the expert system.

When form instance data is recorded in the data store 330 based on human interpretation of response messages by the data collection user, the data collection processing system 320 facilitates processing and storage of the human interpretation provided by the data collection user 321 in knowledge base data associated with the expert system 322 such that the expert system 322 can continue to be trained and refined. Therefore, if the same or a similar response is encountered by the expert system 322 for a future response message from a user 311, the expert system 322 can interpret the message based on the updated knowledge base data.

In a particular embodiment, the user 311 may request that the form instance data to be presented and in a traditional form-completion manner. For example, the user 311 may transfer a message via the conversational interface 600 such as “Can I fill out the form?”. In response to the expert system 322 interpreting that the user 311 has requested that the form instance data is no longer being collected using a conversational based process, the data collection processing system 550 is configured to transfer the form instance data to the data entry processing system 320 wherein the form instance data includes data collected during the data collection session.

As shown in FIG. 5, a third party communication/messaging service can be utilised to conduct the conversational data entry process. Thus, a third party server processing system 510 may provide the communication/messaging service which is utilised to relay messages between the data entry processing system 310 and the data collection processing system 320. As different users 311 may have a preference for one particular communication/messaging service over another, the data collection processing system 320 can be in data communication with a plurality of third party server processing systems 510a-510n enabling different communication/messaging services.

In a preferable form, at least some of the third party server processing systems 510a-510n utilised by the data collection processing system 320 for facilitating the conversation with the user 311 may provide an API enabling the data processing system 320 to remotely call one or more functions of the API to transfer and receive data from the user without needing to execute a client computer program 315 of the third party communication/messaging service.

A sample conversation is provided below in Table 1 showing the various messages transferred and received by the expert system 322, the human operator operating as the data collection user 321 and an explanation of various actions undertaken due to the received data and the various conclusions reached by the expert system 322.

TABLE 1
Example data collection conversation

| Expert System/Human operator | User | Explanation |
|---|---|---|
| (Human) Hi. Thank you for | Sure | At this point, the End User is |
| applying for a Research Grant. | | talking to a Human Operator. |
| May I ask you some questions | | The operator hands control to |
| relating to your application, and fill | | the Expert System to continue |
| out the application form on your | | the process. |
| behalf? | | |
| Please type “?” at any time if you'd | John | |
| like more explanation. What's your | | |
| First Name? | | |
| Hi John. What's your Last Name? | Doe | |
| What is your date of birth? | Sep. 11, 1961 | The expert system needs to |
| | | clarify the data entry, as it could |
| | | not determine whether |
| | | MM/DD/YY or DD/MM/YY |
| | | format was being used. |
| Did you mean a) 11^{th} September | A | |
| 1961, or b) 9^{th} November 1961? | | |
| Just type a or b . . . | | |
| What is your Email Address | someuser@gmail | This answer does not pass |
| | | validation in the form. |
| I'm sorry, that doesn't look like a | someuser@gmail.com | |
| valid email address. Please enter an | | |
| email address in the form | | |
| “name@site.com” | | |
| Thank you. What is your gender? | None of your business. | At this point, the Expert System |
| | | does not understand the |
| | | response (unknown response). It |
| | | hands control over to a human |
| | | operator. |
| (Human.) I'm sorry, let me clarify. | OK. Male | The human operator now hands |
| In order for us to process your | | control back to the Expert |
| grant, we do need to know your | | System. The Expert System |
| gender in order to help to verify | | ignores “OK”, and will interpret |
| your identify. Unfortunately, this | | Male, M, Man and various other |
| information is required by federal | | variations as Male. |
| law. | | |
| Thank you. What is your GAN? | What's a GAN? | At this point, the Expert System |
| | | identifies the response as a |
| | | query. The Expert System |
| | | interrogates the Form |
| | | Interpreter about help content in |
| | | the Form Definition relating to |
| | | this field. |
| A GAN is your Grant Application | Hang on, I've got it | The Expert System ignores the |
| Number. If you have a valid GAN, | somewhere. Got it. It's 289- | surrounding text, and identifies |
| it will speed up processing of your | 890-99 | the GAN. |
| Grant. You can still apply for a | | |
| Grant without a GAN. If you don't | | |
| have a GAN, you can apply for one | | |
| at the end of this. | | |
| Thank you, John. I have everything | That's great, thank you. | The Expert System will submit |
| I need for now. I will process your | | the form for back-office |
| application, and send you a copy of | | processing. |
| your application form to the email | | |
| address you gave me. | | |
| Is there anything else I can do for | No thank you, I'm done. | If an affirmative response had |
| you? | | been received, the Expert |
| | | System would have handed |
| | | control back to a Human |
| | | operator. |

Whilst the figures only show a single user 31 and a single data entry processing system, this is merely due to clarity. It will be appreciated that the data collection system 300 can include a plurality of data entry processing system operated by a respective plurality of users 311, wherein the plurality of data entry processing systems 310 are in data communication with the data collection processing system via the one or more communication/messaging services.

Many modifications within the scope of the invention will be appreciated by those skilled in the art without department from the spirit of the invention.

What is claimed is:

1. A method performed by a data collection processing system for conducting a data collection session to complete a form for a user, wherein the method includes:
transferring a message indicative of a form question of a form via a communication service for presentation in a conversational format upon a data entry processing system;
receiving, via the communication service, a response in a conversational format from the user operating the data entry processing system;
attempting to interpret the response using an expert system;
in the event that the response data is interpreted as an answer to the form question, recording the answer in a data store as part of form instance data; and
in the event that the response cannot be interpreted by the expert system, facilitating a data collection user to conduct a portion of the data collection session via the data collection processing system, wherein the method subsequently includes receiving input from the data collection user that the expert system is to continue interpreting further responses received from the data entry processing system during the form collection session.

2. The method according to claim 1, wherein in the event that the response data is interpreted as the answer to the form question, the method includes determining, using a form interpreter and form definition data, if the answer is valid, wherein in response to the answer being invalid, the method further includes the expert system generating and transferring a further message to the data entry processing system indicative of the answer being invalid and re-presenting the form question.

3. The method according to claim 1, wherein the method further includes the expert system interpreting the response data as being indicative of a query, wherein the expert system is configured to generate a query response based on knowledge base data and transfer the query response to the data entry processing system via the communication service.

4. The method according to claim 1, the method further includes:
accessing form data stored in a data store including a form definition file defining a plurality of form fields of the form;
obtaining a caption associated with one of the form fields defined by the form definition file to generate the message indicative of the form question.

5. The method according to claim 1, wherein the method further includes the data collection processing system:
receiving interpretation data indicative of an interpretation of the response by the data collection user is used by the data collection processing system; and
updating knowledge base data for the expert system based on the interpretation data.

6. The method according to claim 1, wherein the data collection processing system is a distributed processing system including a server processing system in data communication with a data collection client processing system operated by the data collection user, wherein in the event that the response cannot be interpreted by the expert system the method further includes the server processing system transferring a data collection interface to the data collection client processing system for enabling the data collection user to conduct a portion of the data collection session.

7. The method according to claim 6, wherein the method includes the server processing system generating the data collection interface to include a conversational portion indicative of the message and the response, and a form instance portion indicative of the form instance data.

8. A data collection processing system for conducting a data collection session to complete a form for a user, wherein the data collection processing system includes a memory coupled to a processor configured to:
transfer a message indicative of a form question of a form via a communication service for presentation in a conversational format upon a data entry processing system;
receive, via the communication service, a response in a conversational format from the user operating the data entry processing system;
attempt to interpret the response using an expert system;
in the event that the response data is interpreted as an answer to the form question, record the answer in the memory as part of form instance data; and
in the event that the response cannot be interpreted by the expert system, facilitate a data collection user to conduct a portion of the data collection session via the data collection processing system, wherein the method subsequently includes receiving input from the data collection user that the expert system is to continue interpreting further responses received from the data entry processing system during the form collection session.

9. The data collection processing system according to claim 8, wherein the data collection processing system includes a form interpreter, wherein in the event that the response data is interpreted as the answer to the form question, the form interpreter is configured to determine, using form definition data of the form, if the answer is valid, wherein in response to the answer being invalid, the expert system is configured to generate and transfer a further message to the data entry processing system indicative of the answer being invalid and re-presenting the form question.

10. The data collection processing system according to claim 8, wherein in the expert system interprets the response data as being indicative of a query, wherein the expert system is configured to generate a query response based on knowledge base data and transfer the query response to the data entry processing system via the communication service.

11. The data collection processing system according to claim 8, the expert system is configured to:
access form data stored in a data store including a form definition file defining a plurality of form fields of the form; and
obtain a caption associated with one of the form fields to generate the message indicative of the form question.

12. The data collection processing system according to claim 8, wherein the data collection processing system is further configured to:
receive interpretation data indicative of an interpretation of the response by the data collection user is used by the data collection processing system; and
update knowledge base data for the expert system based on the interpretation data.

13. The data collection processing system according to claim 12, wherein the data collection processing system is a distributed processing system including a server processing system in data communication with a data collection client processing system operated by the data collection user, wherein in the event that the response cannot be interpreted by the expert system, the server processing system is configured to transfer a data collection interface to the data collection client processing system for enabling the data collection user to conduct a portion of the data collection session.

14. The data collection processing system according to claim 13, wherein the server processing system is configured to generate the data collection interface to include a conversational portion indicative of the message and the response, and a form instance portion indicative of the form instance data.

15. A non-transient computer readable medium for configured a data collection processing system for conducting a data collection session to complete a form for a user, wherein the non-transient computer readable medium includes executable instructions for configured the data collection processing system to:
transfer a message indicative of a form question of a form via a communication service for presentation in a conversational format upon a data entry processing system;
receive, via the communication service, a response in a conversational format from the user operating the data entry processing system;
attempt to interpret the response using an expert system;
in the event that the response data is interpreted as an answer to the form question, record the answer in the memory as part of form instance data; and
in the event that the response cannot be interpreted by the expert system, facilitate a data collection user to conduct a portion of the data collection session via the data collection processing system, wherein the method subsequently includes receiving input from the data collection user that the expert system is to continue interpreting further responses received from the data entry processing system during the form collection session.

16. The non-transient computer readable medium according to claim 15, wherein the data collection processing system includes a form interpreter, wherein in the event that the response data is interpreted as the answer to the form question, the form interpreter is configured to determine, using form definition data of the form, if the answer is valid, wherein in response to the answer being invalid, the expert system is configured to generate and transfer a further message to the data entry processing system indicative of the answer being invalid and re-presenting the form question.

17. The non-transient computer readable medium according to claim 15, wherein in the expert system interprets the response data as being indicative of a query, wherein the expert system is configured to generate a query response based on knowledge base data and transfer the query response to the data entry processing system via the communication service.

18. The non-transient computer readable medium according to claim 15, the expert system is configured to:
access form data stored in a data store including a form definition file defining a plurality of form fields of the form; and
obtain a caption associated with one of the form fields to generate the message indicative of the form question.

19. The non-transient computer readable medium according to claim 15, wherein the data collection processing system is further configured to:
receive interpretation data indicative of an interpretation of the response by the data collection user is used by the data collection processing system; and
update knowledge base data for the expert system based on the interpretation data.

20. The non-transient computer readable medium according to claim 15, wherein the data collection processing system is a distributed processing system including a server processing system in data communication with a data collection client processing system operated by the data collection user, wherein in the event that the response cannot be interpreted by the expert system, the server processing system is configured to transfer a data collection interface to the data collection client processing system for enabling the data collection user to conduct a portion of the data collection session.
